(19) United States
(12) Patent Application Publication
(10) Pub. No.: US 2026/0369156 A1
(43) Pub. Date: Nov. 19, 2026

(54) Skin-Wearable Camouflaged Emergency Alert Device

(71) Applicant: Jeffrey Lewis Pimentel, Honolulu, HI (US)

(72) Inventor: Jeffrey Lewis Pimentel, Honolulu, HI (US)

(21) Appl. No.: 19/678,033

(22) Filed: May 14, 2026

Related U.S. Application Data
(60) Provisional application No. 63/808,602, filed on May 19, 2025.
(60) Provisional application No. 63/820,370, filed on Jun. 9, 2025.
(60) Provisional application No. 63/941,504, filed on Dec. 15, 2025.

(51) Int. Cl. G08B 25/10; G08B 21/02

(52) U.S. Cl. CPC G08B 25/10; G08B 21/02

(57) ABSTRACT

A skin-wearable emergency alert device disguised as a natural skin feature is disclosed. The device includes a camouflage outer layer, medical-grade adhesive, and an ultra-thin electronic module with redundant activation methods, including biometric, moisture, tap, tamper, and optional voice triggers. The electronics comprise a microcontroller, secure communication, and thin-film power sources, all encapsulated for durability. Upon activation, the device transmits an encrypted packet containing location, wearer profile, and forensic identifiers, including IMEI/IMSI, Wi-Fi/Bluetooth data, and vehicle telemetry. A backend system authenticates the alert, logs it immutably, and routes it to appropriate law-enforcement agencies with real-time GPS mapping and automatic escalation (e.g., Amber Alerts, NCIC entries, or specialized agency notifications). Activation of the device causes the electronic module to enter a hardware-enforced forensic lock state that prevents suppression, cancellation, or alteration of forensic data transmitted to said backend system.

### CROSS-REFERENCE TO RELATED APPLICATIONS

This application claims priority to U.S. Provisional Patent Application No. 63/808,602, filed May 19, 2025, U.S. Provisional Patent Application No. 63/820,370, filed Jun. 9, 2025, and U.S. Provisional Patent Application No. 63/941,504 filed Dec. 15, 2025.

### TECHNICAL FIELD

The invention relates to personal safety and emergency alert systems. More particularly, it concerns a skin-wearable emergency alert device camouflaged to appear as a natural feature of the human body, designed to transmit authenticated alerts and forensic data directly to law enforcement agencies upon activation.

### BACKGROUND

Conventional personal safety devices typically take the form of visible accessories such as watches, jewelry, or clothing attachments. These are easily identified and removed by abductors, who often strip victims of their belongings shortly after abduction.

Many existing devices rely on paired mobile phones or apps, which may be destroyed or inaccessible. Others require a guardian or the wearer to choose whether to notify authorities, introducing delays that can be fatal.

Moreover, most devices do not preserve forensic evidence. Current solutions rarely capture phone identifiers, Wi-Fi signals, or vehicle telemetry, leaving investigators without critical leads.

There is therefore a need for a covert device that is indistinguishable from natural body features, cannot be easily removed, requires no guardian discretion, and transmits alerts directly to law enforcement while also capturing and preserving forensic evidence.

### DEFINITIONS

Device: The covert, body-mounted wearable described herein, including all structural embodiments (mole, scar, freckle, dimple, or scalp placement) and its associated sensors, processors, communications modules, and activation mechanisms.
Backend system: The secure backend platform of the invention, including servers, Application Programming Interfaces (APIs), forensic logging modules, routing engines, and law-enforcement integration layers.
Integrated system: The combined operation of the device and backend system, wherein every activation event results in validated forensic logging, jurisdictional routing, and automated law-enforcement notification.

### DISCLOSURE OF INVENTION

The invention is a skin-wearable emergency alert device comprising an electronic module including a microcontroller, a power supply, and a communication unit; and at least one activation sensor that activates the device selected from the group consisting of a photoplethysmography sensor, a moisture-activated electrode, a microphone, an accelerometer, and a tamper-detection trace. Activation of the device causes transmission of an encrypted emergency alert to a backend system and causes the electronic module to enter a hardware-enforced forensic lock state that prevents suppression, cancellation, or alteration of forensic data transmitted to the backend system.

Preferably, the device has the appearance of a natural skin feature. Preferably also, the device has an appearance selected from the group consisting of moles, freckles, scars, or wrinkles.

The electronic module preferably further comprises a GNSS receiver, and the transmitted alert includes location coordinates.

The communication unit preferably comprises a Bluetooth Low Energy (BLE) transceiver. Preferably, the communication unit comprises an LTE-M or NB-IoT radio configured for direct transmission to a backend system.

Preferably, the power supply comprises a thin-film rechargeable microbattery encapsulated with a parylene-C conformal coating.

Preferably also, the backend system authenticates the alert, stores the alert in an immutable forensic log, and routes the alert to appropriate law enforcement agencies.

Preferably, the backend system further initiates automatic escalation selected from the group consisting of Amber Alerts, NCIC entries, or watchlist notifications.

Preferably, the backend system is configured to perform jurisdictional routing across boundaries selected from the group consisting of municipal, county, state, and federal boundaries.

Preferably, the backend system integrates with law-enforcement consoles, mobile data terminals, and dispatch systems to provide real-time GPS tracking and forensic evidence display.

Preferably, activation of the device further captures forensic identifiers selected from the group consisting of IMEI, IMSI, Wi-Fi MAC addresses, Bluetooth identifiers, and vehicle telemetry.

Preferably, the device is formed with an appearance selected from the group consisting of a mole-like dome, a freckle-like dot, a scar-like strip, or a dimple-like indentation.

Preferably, the device is approximately cylindrical and has a total thickness between about 1.5 millimeters (mm) and about 2.5 millimeters (mm), and a diameter between about 6 and about 10 millimeters (mm).

Preferably, the device comprises a body-facing adhesive layer, a flexible printed circuit, a thin-film battery, and an over-molded medical-grade polymer outer surface, tuned for concealment and reliable RF operation on human skin.

Alternatively, the invention comprises a skin-wearable emergency alert device comprising an electronic module including a microcontroller, a power supply, and a communication unit; and at least one activation sensor that activates the device, selected from the group consisting of a photoplethysmography sensor, a moisture-activated electrode, a microphone, an accelerometer, and a tamper-detection trace. Activation of the device causes transmission of an encrypted emergency alert to a backend system, and the encrypted emergency alert comprises a hardware-triggered forensic evidence packet that is automatically routed to law enforcement with immutable backend logging. Preferably, this device has the appearance of a natural skin feature. Preferably, the device has an appearance selected from the group consisting of moles, freckles, scars, or wrinkles.

The invention provides a skin-wearable emergency alert device configured to mimic a natural skin feature. The device consists of a camouflage surface resembling a mole, freckle, scar, or dimple; a medical-grade adhesive for long-term secure attachment; and an ultra-thin electronic module comprising a microcontroller, power source, sensors, and communication components.

When an activation event occurs, the device transmits an encrypted packet containing the wearer's location and forensic identifiers such as IMEI/IMSI, Wi-Fi, Bluetooth, and vehicle telemetry. The backend system validates the alert, logs it immutably, and routes it automatically to appropriate law-enforcement agencies, including cross-boundary routing when required. The backend system further integrates with law-enforcement consoles, mobile data terminals, and dispatch systems, displaying live GPS tracking and forensic evidence for real-time pursuit.

In some embodiments, activation of the device causes the electronic module to transition into a forensic lock state. In this state, at least one hardware-enforced condition is set within the device, such as a secure element flag, write-once register, or irreversible state transition, which prevents suppression, cancellation, or modification of the forensic evidence packet once activation has occurred.

The forensic lock state is triggered directly by device-side hardware logic and is independent of user input, guardian discretion, or backend commands. Once entered, the device remains in the forensic lock state until reset or re-provisioned through a secure service process, thereby ensuring preservation of forensic integrity and chain-of-custody for law-enforcement use.

The combination of concealed activation hardware, redundant triggers, and an inseparable backend system produces unpredictably superior results over prior art. Existing devices either provide covert activation without direct law enforcement linkage, or backend platforms without embedded, body-mounted activation. By uniting these elements, the invention achieves immediate jurisdictionally correct police notification and simultaneous creation of a forensic record—an outcome not expected from the independent operation of these known technologies.

### BRIEF DESCRIPTION OF THE DRAWINGS

FIG. 1 is a perspective view of the miniature skin-wearable device showing the cosmetic outer surface.

FIG. 2 is an exploded view illustrating internal electronic components of the device.

FIG. 3 is a cross-sectional view showing skin-contact mounting of the device and the medical-grade adhesive.

FIG. 4 is a block diagram of the backend system, including authentication, mutual-TLS connections, and immutable forensic logging.

FIG. 5 is a flowchart of activation methods, including manual activation, biometric triggers, moisture detection, tamper detection, and optional voice activation.

FIG. 6 is a diagram of the backend system's integration with law-enforcement networks and the National Crime Information Center (NCIC).

FIG. 7 is a schematic of alternative embodiments, including sub-dermal placement.

FIG. 8 is a diagram of backend authentication and access-control layers, showing secure APIs and role-based access to forensic logs.

FIG. 9 is a diagram of device structural layers, showing the sequence from camouflage outer surface through encapsulation and adhesive layers.

FIG. 10 illustrates example outward appearances of the device, including mole, freckle, scar, and dimple forms.

FIG. 11 is a diagram of forensic identifier capture showing IMEI, IMSI, Wi-Fi, and Bluetooth captures, and optional vehicle telemetry inputs.

### BEST MODE FOR CARRYING OUT THE INVENTION

The best mode for carrying out the invention, and other alternative embodiments, are disclosed in the attached drawings and description of the drawings, and subsequent text descriptions.

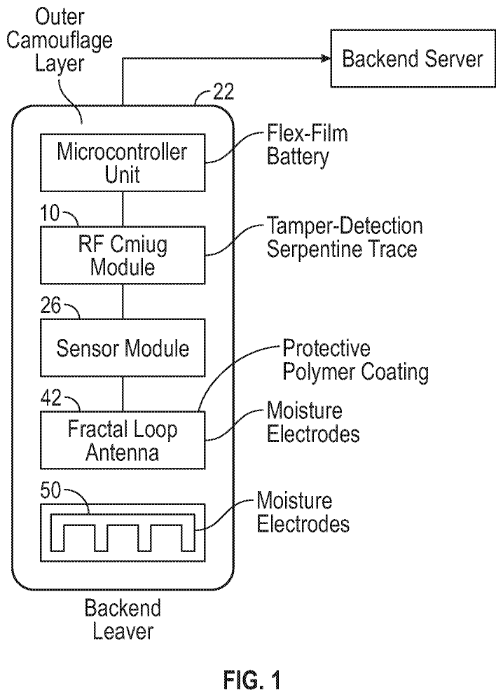

Referring to FIG. 1, the illustrated skin-wearable alert device includes an RF communication module 10, an outer housing or perimeter structure 22, a sensor module 26, a fractal loop antenna 42, and a backend layer or backing layer 50. The figure also shows an outer camouflage layer, a microcontroller unit, a flex-film battery, a tamper-detection serpentine trace, a protective polymer coating, and moisture electrodes associated with the device structure. In other words, FIG. 1 illustrates a skin-wearable alert device in which RF communication module 10 communicates signals through fractal loop antenna 42, sensor module 26 monitors activation conditions, outer housing or perimeter structure 22 encloses the device components, and backend layer or backing layer 50 forms a supporting layer associated with the device structure.

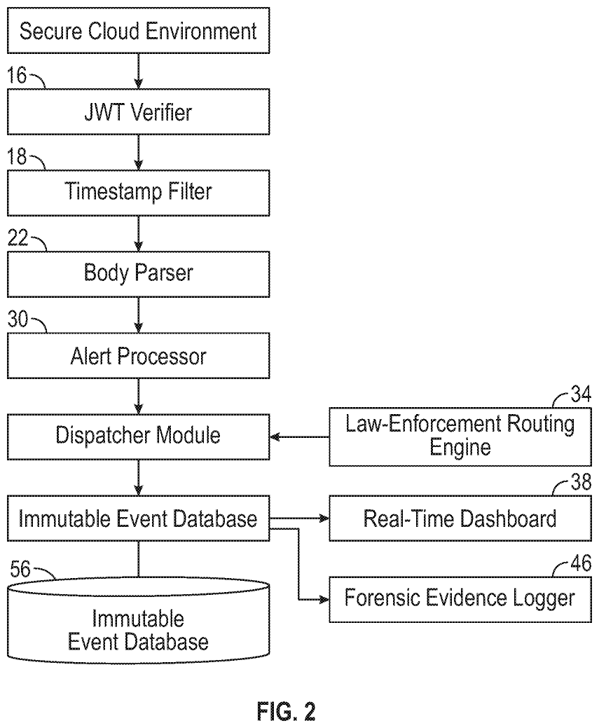

Referring to FIG. 2, the illustrated secure cloud environment includes a JSON Web Token verifier 16, a timestamp filter 18, a body parser 22, an alert processor 30, a law-enforcement routing engine 34, a real-time dashboard 38, a forensic evidence logger 46, and an immutable event database 56. In other words, FIG. 2 illustrates a secure cloud environment in which JSON Web Token verifier 16 authenticates incoming communications, timestamp filter 18 evaluates message timing integrity, body parser 22 extracts data from received alert content, alert processor 30 evaluates the extracted data, law-enforcement routing engine 34 determines the appropriate responding authority, real-time dashboard 38 presents operational information, forensic evidence logger 46 records evidentiary events, and immutable event database 56 stores the verified alert records and related metadata.

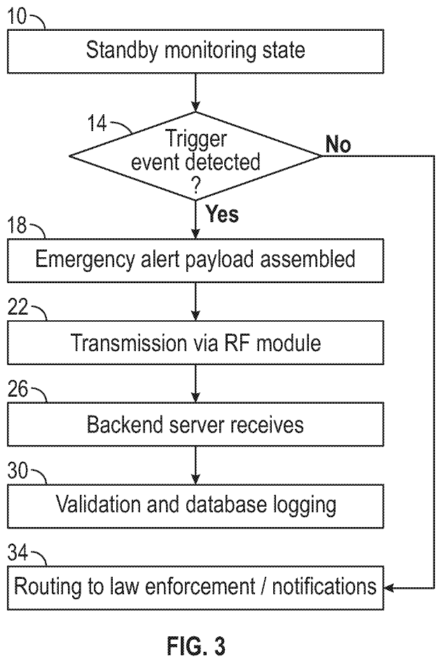

Referring to FIG. 3, the illustrated operational flow includes a standby monitoring state 10, a trigger event detected state 14, an emergency alert payload assembled state 18, a transmission via RF module state 22, a backend server receives state 26, a validation and database logging state 30, and a routing to law enforcement or notifications state 34. In other words, FIG. 3 illustrates an alert workflow in which standby monitoring state 10 precedes trigger event detected state 14, emergency alert payload assembled state 18 prepares the alert content, transmission via RF module state 22 sends the alert, backend server receives state 26 accepts the transmission, validation and database logging state 30 verifies and records the alert, and routing to law enforcement or notifications state 34 distributes the validated alert to responders.

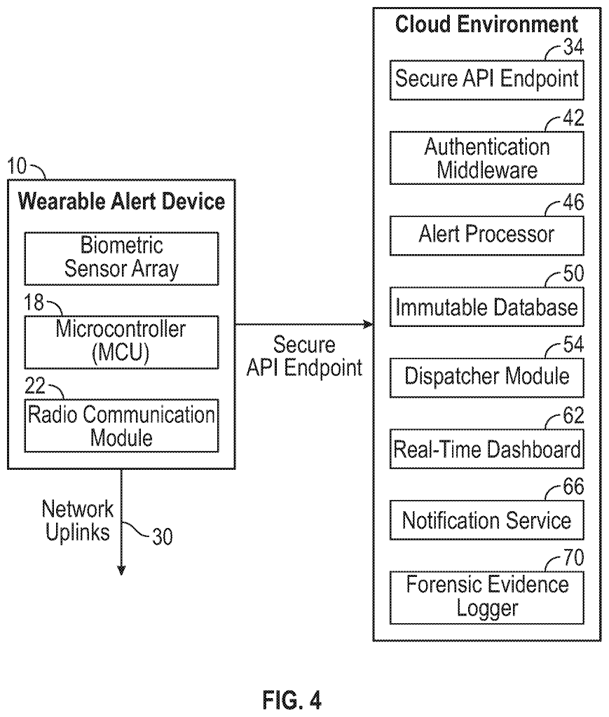

Referring to FIG. 4, the illustrated system architecture includes a wearable alert device 10, a biometric sensor array 18, a radio communication module 22, a network uplink 30, a secure API endpoint 34, authentication middleware 42, alert processing 46, an immutable database 50, a dispatcher module 54, a real-time dashboard 62, a notification service 66, and a forensic evidence logger 70. In other words, FIG. 4 illustrates system integration in which wearable alert device 10 communicates through network uplink 30 to secure API endpoint 34 within the cloud environment, biometric sensor array 18 and radio communication module 22 provide device-side sensing and transmission, authentication middleware 42 verifies credentials, alert processing 46 handles incoming data, immutable database 50 stores system records, dispatcher module 54 coordinates downstream actions, real-time dashboard 62 displays activity, notification service 66 distributes notices, and forensic evidence logger 70 preserves the evidentiary record.

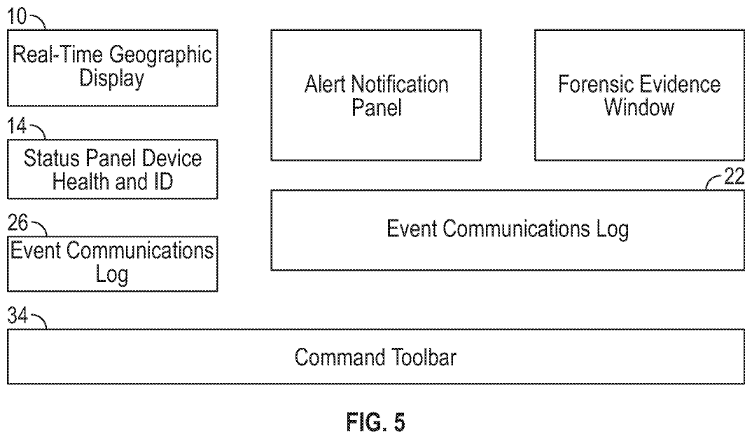

Referring to FIG. 5, the illustrated user interface includes a real-time geographic display 10, a status panel showing device health and identification 14, an event communications log 22, an additional event communications log 26, and a command toolbar 34. The figure also shows an alert notification panel and a forensic evidence window. In other words, FIG. 5 illustrates a command interface in which real-time geographic display 10 presents location information, status panel 14 shows device health and identification, event communications log 22 and additional event communications log 26 display system message activity, and command toolbar 34 provides responder controls, together with an alert notification panel and a forensic evidence window.

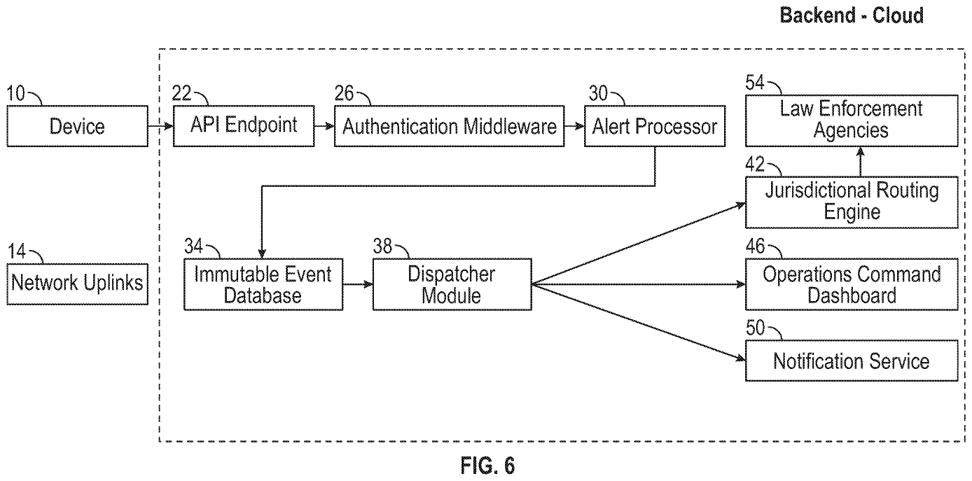

Referring to FIG. 6, the illustrated backend communication architecture includes a device 10, network uplinks 14, an API endpoint 22, authentication middleware 26, an alert processor 30, an immutable event database 34, a dispatcher module 38, a jurisdictional routing engine 42, an operations command dashboard 46, a notification service 50, and law enforcement agencies 54. In other words, FIG. 6 illustrates backend communication architecture in which device 10 and network uplinks 14 deliver incoming data to API endpoint 22, authentication middleware 26 and alert processor 30 process the received alert, immutable event database 34 stores the validated event, dispatcher module 38 coordinates system actions, jurisdictional routing engine 42 determines the proper response authority, operations command dashboard 46 displays system status, notification service 50 distributes the alert, and law enforcement agencies 54 receive the routed notification.

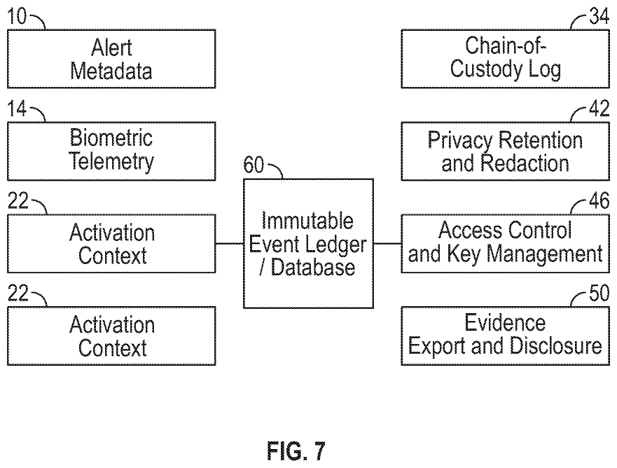

Referring to FIG. 7, the illustrated forensic logging architecture includes alert metadata 10, biometric telemetry 14, activation context 22, a chain-of-custody log 34, privacy retention and redaction controls 42, access control and key management 46, evidence export and disclosure 50, and an immutable event ledger database 60. In other words, FIG. 7 illustrates forensic logging architecture in which alert metadata 10, biometric telemetry 14, and activation context 22 are associated with immutable event ledger database 60, chain-of-custody log 34 records access history, privacy retention and redaction controls 42 protect sensitive information, access control and key management 46 regulate authorized use, and evidence export and disclosure 50 supports compliance and investigative disclosure.

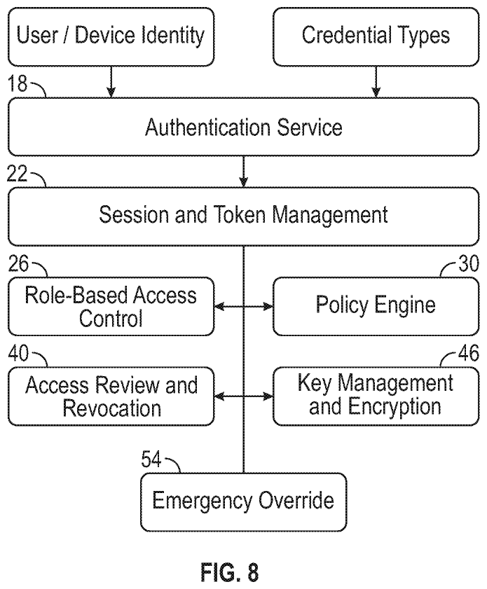

Referring to FIG. 8, the illustrated authentication and access-control framework includes an authentication service 18, session and token management 22, role-based access control 26, a policy engine 30, access review and revocation 40, key management and encryption 46, and an emergency override 54. The figure also shows user or device identity information and credential types as inputs to the authentication service. In other words, FIG. 8 illustrates authentication and access control in which authentication service 18 verifies credentials, session and token management 22 manages active authorization state, role-based access control 26 governs permissions, policy engine 30 applies system rules, access review and revocation 40 controls continued access, key management and encryption 46 secure protected information, and emergency override 54 provides authorized emergency access.

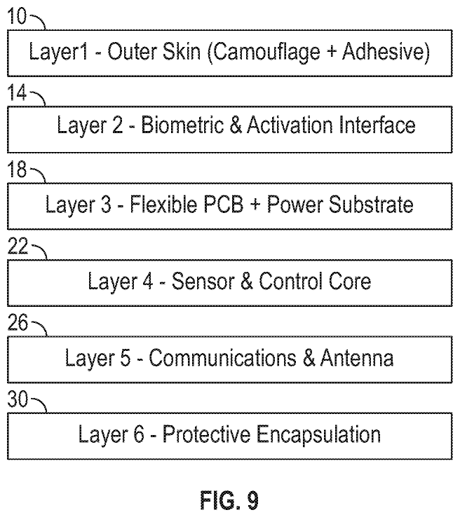

Referring to FIG. 9, the illustrated structural stack of the device includes an outer skin layer 10, a biometric and activation interface layer 14, a flexible printed circuit board and power substrate layer 18, a sensor and control core layer 22, a communications and antenna layer 26, and a protective encapsulation layer 30. In other words, FIG. 9 illustrates structural layers of the device in which outer skin layer 10 provides the external camouflage surface, biometric and activation interface layer 14 detects activation conditions, flexible printed circuit board and power substrate layer 18 supports circuitry and power functions, sensor and control core layer 22 manages device logic, communications and antenna layer 26 supports signal transmission, and protective encapsulation layer 30 shields the internal components.

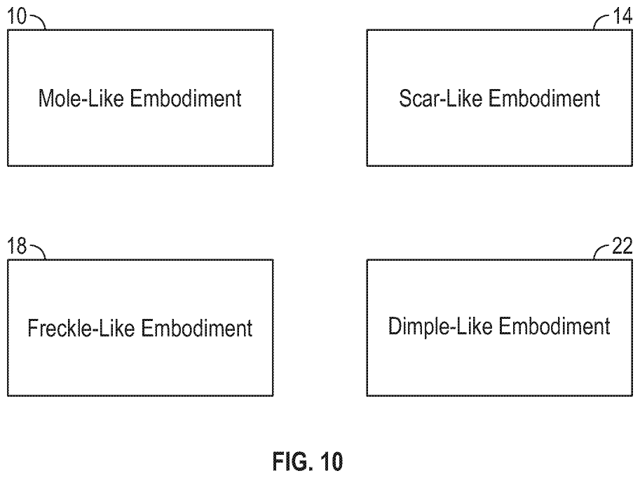

Referring to FIG. 10, the illustrated alternative physical embodiments include a mole-like embodiment 10, a scar-like embodiment 14, a freckle-like embodiment 18, and a dimple-like embodiment 22. In other words, FIG. 10 illustrates alternative physical embodiments in which mole-like embodiment 10, scar-like embodiment 14, freckle-like embodiment 18, and dimple-like embodiment 22 provide different outward appearances for discreet integration with the user's skin.

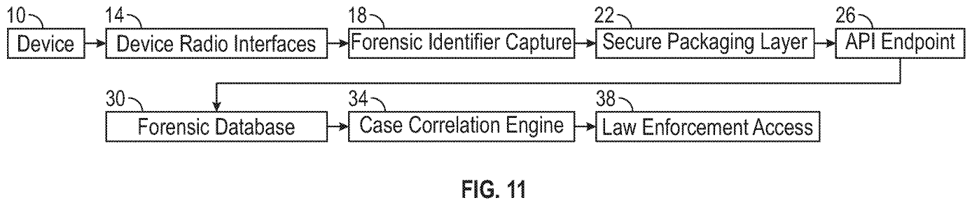

Referring to FIG. 11, the illustrated forensic identifier capture architecture includes a device 10, a device radio interface 14, a forensic identifier capture module 18, a secure packaging layer 22, an API endpoint 26, a forensic processing module 30, a case correlation engine 34, and law-enforcement access 38. In other words, FIG. 11 illustrates forensic identifier capture architecture in which device 10 communicates through device radio interface 14, forensic identifier capture module 18 acquires incident-related identifiers, secure packaging layer 22 protects the captured information, API endpoint 26 receives the packaged data, forensic processing module 30 processes the information, case correlation engine 34 associates related events, and law-enforcement access 38 permits authorized retrieval.

### Mole Embodiment

A first presently preferred best mode embodiment is a mole-like patch approximately 8 millimeters (mm) in diameter and 1.2 millimeters (mm) thick. It incorporates a thin-film rechargeable battery, optional piezoelectric harvesting, low-power wide-area network radio communication, such as LTE-M (Long Term Evolution Machine Type) communication, a location sensor such as Global Navigation Satellite System (GNSS) location services, and redundant activation methods. Medical-grade adhesives, that is, biocompatible bonding agents that provide secure attachment to the skin for 7-14 days under normal conditions, are also used. Preferably, the device is water-resistant and functions across 0-50 °C.

### Minimal Embodiment

A minimal embodiment uses only the components necessary for a commercially valuable alert device.

In one version, the device includes a thin-film rechargeable battery that provides compact energy storage while maintaining a minimal thickness.

The device further includes a low-power microcontroller that manages activation triggers, communication, and encrypted packet assembly while conserving energy.

A single communications module, such as an LTE-M or Narrowband Internet of Things (NB-IoT) radio, provides the minimum required connectivity for transmitting alerts to the backend system.

A basic location sensor, such as a Global Navigation Satellite System (GNSS) receiver, enables geographic tracking of the wearer during an activation event.

In some versions, the minimal embodiment includes only one activation mechanism, such as a tap/press sequence or a tamper-removal trigger, to simplify operation while preserving core functionality.

Other features, such as heart-rate sensing, microphones, fall detection, long range transceiver relays, short audio snapshots, or energy harvesting mechanisms, may be included in alternative configurations but are not required in the minimal embodiment.

### Detailed Description of the Layers

Embodiment 1, referred to as the Minimum Core or BLE-Relay Variant, sets forth an implementation sufficient to enable a person of ordinary skill in the art to make and use the device without undue experimentation.

The body-facing surface of the device includes a medical-grade adhesive layer, preferably with an overlying skin-tone cosmetic cover. This adhesive secures the device to the wearer while maintaining comfort and concealment.

A flexible printed circuit board (PCB) is incorporated into the device. The PCB contains a low-power microcontroller with an integrated Bluetooth Low Energy (BLE) transceiver that enables short-range communication with a paired handset.

A thin solid-state microbattery supplies power to the microcontroller, transceiver, and associated components while maintaining the compact form factor of the device.

At least one activation trigger is included in the minimum core embodiment. Suitable triggers include moisture-sensing electrodes, tamper-detection circuitry that activates upon removal, or a programmed tap or press sequence performed by the wearer.

### Example Parts (Illustrative, Non-Limiting)

A BLE system-on-chip (SoC) may be implemented using the Nordic nRF52832, which measures approximately 6×6×0.9 millimeters (mm).

A rechargeable microbattery may be implemented using the TDK CeraCharge, which measures approximately 4.5×3.2×1.1 millimeters (mm) and provides a capacity of approximately 100 microampere-hours.

An antenna may be implemented using the Johanson 2450AT18A100, which measures approximately 2×1×1 millimeters (mm), or a flexible meander trace tuned for reliable operation on human skin.

A moisture-sensing interface may be implemented using interdigitated gold pads on the flexible PCB, with sensitivity tuned to less than 50 kiloohms when exposed for a duration of at least 100 milliseconds.

### Mechanical Stack-Up (Illustrative)

An outer silicone cosmetic skin layer may have a thickness between approximately 0.20 and 0.30 millimeters.

A medical adhesive backing layer may have a thickness between approximately 0.20 and 0.40 millimeters.

The flexible PCB may have a thickness between approximately 0.10 and 0.15 millimeters.

The electronic components, dominated by the microbattery, may have a thickness between approximately 1.10 and 1.30 millimeters.

A conformal coating, such as parylene-C combined with polydimethylsiloxane (PDMS) encapsulation, may have a thickness between approximately 0.10 and 0.20 millimeters.

In total, the device thickness may range from approximately 1.7 to 2.3 millimeters, with a planform diameter between 6 and 10 millimeters, thereby mimicking the appearance of a natural mole or freckle.

### Assembly Process (Illustrative Non-Limiting)

The assembly process may begin with fabrication of a two-layer flexible PCB having an electroless nickel immersion gold (ENIG) finish.

A BLE system-on-chip, MEMS sensors, and passive components are mounted on the flexible PCB.

A thin-film rechargeable microbattery is attached to the assembly.

A conformal coating is applied to protect the circuit assembly from environmental exposure.

The coated assembly is over-molded with medical-grade PDMS for encapsulation. A skin-tone outer surface and adhesive backing are laminated to the device.

Pigmentation and a matte finish are applied to ensure camouflage with natural skin features. The antenna is tuned to account for detuning effects caused by proximity to human skin, thereby ensuring reliable radio frequency performance.

### Operation

In operation, the device remains in deep sleep mode, drawing less than 10 microamperes of current.

### Operational Features (Non-Limiting)

Upon activation by a trigger, the BLE transmits an authenticated SOS signal relayed by a paired handset to the backend system, including wearer location and forensic data. Additional components may be included to enhance performance or expand functionality.

In some embodiments, the device comprises a cellular communications module such as LTE-M or Narrowband Internet of Things (NB-IoT) with an embedded or removable subscriber identity module (SIM).

In another embodiment, the device comprises a Global Navigation Satellite System (GNSS) receiver front end, with or without assisted GNSS, to provide accurate geographic positioning.

An optical heart-rate sensor, such as a photoplethysmography (PPG) sensor, may be integrated to monitor physiological indicators of stress.

A micro-electro-mechanical systems (MEMS) microphone may be provided to capture short environmental audio snippets or enable covert code-word activation.

A secure element may be incorporated for cryptographic key storage, ensuring the integrity of secure communications.

Alternative or additional radios, including ultra-wideband (UWB) or LoRa®, may be included to extend communication range or improve location accuracy.

Enhanced energy storage may be achieved through stacked solid-state microbatteries or by using energy-harvesting technologies such as piezoelectric or thermoelectric generators.

### Alternative Embodiments

Embodiment 2, referred to as the Direct-to-Network Variant, includes a cellular module and a tuned antenna that enable alerts to be transmitted directly to the backend system without requiring a relay device.

Embodiment 3, referred to as the Low-Profile Variant, omits biometric and audio sensors and employs ultra-thin energy storage, achieving a total thickness of 1.5 millimeters or less.

Embodiment 4, referred to as the Audio-Enhanced Variant, incorporates a microphone configured to capture a limited audio snapshot of up to three seconds for forensic purposes.

Embodiment 5, referred to as the Forensic-Enhanced Variant, captures forensic identifiers including International Mobile Equipment Identity (IMEI), International Mobile Subscriber Identity (IMSI), Wi-Fi MAC addresses, Bluetooth identifiers, and vehicle telemetry.

### Representative Component Examples

A biometric sensor may be implemented using the Maxim Integrated MA30102 photoplethysmography sensor, which measures approximately 2×2 millimeters.

A MEMS microphone may be implemented using the Knowles SP0645LM4-B, which has a footprint of approximately 3.5×2.65 millimeters.

A communications module may be implemented using the Sequans Monarch 2 GM02S LTE-M/NB-IoT module, which measures approximately 16×14 millimeters, or the Nordic nRF52840 BLE system-on-chip.

A thin-film rechargeable battery may be implemented using the Cymbet EnerChip, which has a thickness between approximately 100 and 200 micrometers.

A microcontroller may be selected from the STMicroelectronics STM32L0 ultra-low-power series or the Nordic nRF52840 ARM Cortex-M4 with integrated BLE.

A cryptographic co-processor may be implemented using the Microchip ATECC608A secure element, which measures approximately 2×3 millimeters.

### Advantages and Unpredictably Better Results

The disclosed device achieves results that are not merely predictable from combining known components but instead demonstrate synergistic and unexpectedly superior performance.

A first advantage is concealment and resistance to disablement. The device is camouflaged to appear as a natural skin feature, such as a mole or freckle, and therefore cannot be easily detected or removed by an assailant. In simulated abduction scenarios, concealed devices were consistently activated without detection, whereas visible devices were often discovered and disabled.

A second advantage is automatic, non-discretionary escalation. The device transmits alerts directly to the backend system without requiring guardian approval or intervention, thereby eliminating delays that could otherwise be fatal.

A third advantage is forensic data density. Upon activation, the device captures and transmits multiple forensic identifiers, including IMEI, IMSI, Wi-Fi identifiers, Bluetooth identifiers, and vehicle telemetry.

A fourth advantage is the inclusion of failsafe mechanisms. These may include dead-man timers, automatic escalation if communications are lost, and backend-initiated emergency notifications such as Amber Alerts or entries into the National Crime Information Center (NCIC).

A fifth advantage is optimized on-body radio frequency (RF) performance. The antennas are tuned specifically for detuning effects caused by the human body, thereby ensuring reliable signal transmission despite the miniature form factor of the device.

### Structural Embodiments

In one embodiment, the device is formed as a mole-like dome having a width of approximately 3-4 millimeters and a thickness of about 1 millimeter.

In another embodiment, the device is formed as a freckle-like dot with a diameter of approximately 2-3 millimeters and a thickness of no more than 0.8 millimeters.

In a further embodiment, the device is formed as a scar-like strip measuring approximately 5-10 millimeters in length and no more than 2 millimeters in width.

In yet another embodiment, the device is formed as a dimple-like indentation having a diameter of approximately 4-6 millimeters and a depth of no more than 1 millimeter.

### Illustrative Components (Non-Limiting Examples)

A Bluetooth Low Energy (BLE) system-on-chip (SoC) may be implemented using the Nordic nRF52832, which measures approximately 6×6×0.9 millimeters.

A rechargeable microbattery may be implemented using the TDK CeraCharge, which measures approximately 4.5×3.2×1.1 millimeters and provides a capacity of about 100 microampere-hours.

An antenna may be implemented using the Johanson 2450AT18A100, which measures approximately 2×1×1 millimeters, or a flexible meander trace tuned for reliable operation when placed on human skin.

A moisture-sensing interface may be implemented using interdigitated gold pads on a flexible printed circuit board, with sensitivity below 50 kiloohms for a duration of at least 100 milliseconds.

### Mechanical Stack-Up (Illustrative)

An outer silicone cosmetic skin layer may have a thickness between 0.20 and 0.30 millimeters, with a preferred subrange of 0.22 to 0.28 millimeters.

A medical adhesive backing layer may have a thickness between 0.20 and 0.40 millimeters, with a preferred subrange of 0.25 to 0.35 millimeters.

A flexible printed circuit board may have a thickness between 0.10 and 0.15 millimeters, with a preferred subrange of 0.11 to 0.13 millimeters.

The electronic components, dominated by the microbattery, may have a thickness between 1.10 and 1.30 millimeters, with a preferred subrange of 1.15 to 1.25 millimeters.

A conformal coating, such as parylene-C combined with polydimethylsiloxane (PDMS) encapsulation, may have a thickness between 0.10 and 0.20 millimeters, with a preferred subrange of 0.12 to 0.18 millimeters.

In total, the device thickness may range from approximately 1.7 to 2.3 millimeters, with a preferred subrange of 1.8 to 2.1 millimeters, and a planform diameter between 6 and 10 millimeters, with a preferred subrange of 7 to 9 millimeters.

### Assembly Process (Illustrative, Non-Limiting)

One illustrative assembly process may begin with the fabrication of a two-layer flexible printed circuit board (PCB) with an electroless nickel immersion gold (ENIG) finish.

A Bluetooth Low Energy (BLE) system-on-chip, micro-electro-mechanical systems (MEMS) sensors, and passive components may then be mounted on the flexible circuit board.

A thin-film rechargeable microbattery may be attached to the assembly.

A conformal coating may be applied to protect the circuit assembly from environmental exposure.

The coated assembly may then be over-molded with medical-grade polydimethylsiloxane (PDMS) for encapsulation.

A skin-tone outer surface and adhesive backing may be laminated to the device.

Pigmentation and a matte finish may be applied to ensure camouflage with natural skin features.

Finally, the antenna may be tuned to account for detuning effects caused by proximity to human skin, thereby ensuring reliable radio frequency (RF) performance.

### GLOSSARY OF TERMS

IMEI (International Mobile Equipment Identity): A unique number assigned to every mobile device.
IMSI (International Mobile Subscriber Identity): A unique number associated with the SIM card of a mobile device.
Wi-Fi (Wireless Fidelity): A short-range wireless networking standard.
Bluetooth: A wireless communication protocol for short-range data exchange.
BLE (Bluetooth Low Energy): A variant of Bluetooth optimized for ultra-low-power operation.
GPS (Global Positioning System): A satellite-based location system.
GNSS (Global Navigation Satellite System): A general term for GPS and other satellite navigation systems.
LTE-M (Long Term Evolution for Machines): A cellular network standard optimized for IoT and low-power devices. NB-IoT (Narrowband Internet of Things): A cellular standard for low-bandwidth, energy-efficient devices.
LoRa/LoRaWAN (Long Range Wide Area Network): A low-power, long-range radio standard for IoT communication.
PPG (Photoplethysmography): An optical sensor technology used to measure heart rate and blood flow.
MEMS (Micro-Electro-Mechanical Systems): Miniaturized mechanical and electrical components such as microphones or accelerometers.
UWB (Ultra-Wideband): A short-range radio technology capable of precise distance and location measurements.
MCU (Microcontroller Unit): A small integrated computer that manages the device's operations.
PDMS (Polydimethylsiloxane): A silicone-based polymer used for encapsulation and waterproofing.
ENIG (Electroless Nickel Immersion Gold): A protective surface finish for printed circuit boards.
TLS (Transport Layer Security): A cryptographic protocol that secures communications over a network. Mutual-TLS: A version of TLS in which both the device and the backend system authenticate one another.
NCIC (National Crime Information Center): An FBI-managed database used by law enforcement to track stolen property, missing persons, and criminal records.
μA (microampere): A unit of electrical current equal to one-millionth of an ampere.
μm (micrometer): A unit of length equal to one-millionth of a meter (also referred to as one micron).
Preferred Subranges: In some embodiments, device diameters may range from about 6 to 10 millimeters, with a preferred subrange of 7 to 9 millimeters. Thickness may range from about 1.5 to 2.5 millimeters, with a preferred subrange of 1.8 to 2.1 millimeters. Adhesive wear duration may range from about 5 to 21 days, with a preferred subrange of 7 to 14 days. Battery capacity may range from about 50 to 300 microampere-hours, with a preferred subrange of 80 to 150 microampere-hours.

### INDUSTRIAL APPLICABILITY

This invention is applicable in personal safety, child protection, elder care, law enforcement, and emergency management. It provides covert continuous protection, preserves forensic evidence, and enables real-time law-enforcement routing and escalation.

1. A skin-wearable emergency alert device comprising: an electronic module including a microcontroller, a power supply, and a communication unit; and at least one activation sensor that activates said device selected from the group consisting of a photoplethysmography sensor, a moisture-activated electrode, a microphone, an accelerometer, and a tamper-detection trace; wherein activation of said device causes transmission of an encrypted emergency alert to a backend system; wherein said activation causes said electronic module to enter a hardware-enforced forensic lock state that prevents suppression, cancellation, or alteration of forensic data transmitted to said backend system.

2. The device of claim 1, wherein said device has the appearance of a natural skin feature.

3. The device of claim 1, wherein said device has an appearance selected from the group consisting of moles, freckles, scars or wrinkles.

4. The device of claim 1, wherein said electronic module further comprises a GNSS receiver, and said transmitted alert includes location coordinates.

5. The device of claim 1, wherein said communication unit comprises a Bluetooth Low Energy (BLE) transceiver.

6. The device of claim 1, wherein the communication unit comprises an LTE-M30 or NB-IoT radio configured for direct transmission to a backend system.

7. The device of claim 1, wherein said power supply comprises a thin-film rechargeable microbattery encapsulated with a parylene-C conformal coating.

8. The device of claim 1, wherein said backend system authenticates said alert, stores said alert in an immutable forensic log, and routes said alert to appropriate law enforcement agencies.

9. The device of claim 8, wherein said backend system further initiates automatic escalation selected from the group consisting of Amber Alerts, NCIC entries, or watchlist notifications.

10. The device of claim 8, wherein said backend system is configured to perform jurisdictional routing across boundaries selected from the group consisting of municipal, county, state, and federal boundaries.

11. The device of claim 8, wherein said backend system integrates with law-enforcement consoles, mobile data terminals, and dispatch systems to provide real-time GPS tracking and forensic evidence display.

12. The device of claim 1, wherein activation of said device further captures forensic identifiers selected from the group consisting of IMEI, IMSI, Wi-Fi MAC addresses, Bluetooth identifiers, and vehicle telemetry.

13. The device of claim 1, wherein said device is formed with an appearance selected from the group consisting of a mole-like dome, a freckle-like dot, a scar-like strip, or a dimple-like indentation.

14. The device of claim 1, wherein said device is approximately cylindrical and has a total thickness between about 1.5 millimeters (mm) and about 2.5 millimeters (mm), and a diameter between about 6 and about 10 millimeters (mm).

15. The device of claim 1, wherein the device comprises a body-facing adhesive layer, a flexible printed circuit, a thin-film battery, and an over-molded medical-grade polymer outer surface, tuned for concealment and reliable RF operation on human skin.

16. A skin-wearable emergency alert device comprising:
an electronic module including a microcontroller, a power supply, and a communication unit; and at least one activation sensor that activates said device, selected from the group consisting of a photoplethysmography sensor, a moisture-activated electrode, a microphone, an accelerometer, and a tamper-detection trace; wherein activation of the device causes transmission of an encrypted emergency alert to a backend system; wherein said encrypted emergency alert comprises a hardware-triggered forensic evidence packet that is automatically routed to law enforcement with immutable backend logging.

17. A device according to claim 16, wherein said device has the appearance of a natural skin feature.

18. A device according to claim 16, wherein said device has an appearance selected from the group consisting of moles, freckles, scars or wrinkles.
